(19) United States
(12) Patent Application Publication
(10) Pub. No.: US 2003/0212628 A1
(43) Pub. Date: Nov. 13, 2003

(54) Integrated mortgage advice system and method

(76) Inventors: Appu Kuttan, McLean, VA (US); Stuart William Nesbitt II, Alexandria, VA (US)

Correspondence Address: Law Office of Timothy M. Barlow, P.O. Box 523275, Springfield, VA, 22152, US

(21) Appl. No.: 10/431,274

(22) Filed: May 7, 2003

Related U.S. Application Data
(60) Provisional application No. 60/378,502, filed on May 8, 2002.

(51) Int. Cl. G06F 17/60

(52) U.S. Cl. 705/38

(57) ABSTRACT

An integrated mortgage advice system is a business system that provides mortgage-related financial advice to Borrower to help Mortgage Professionals maintain positive relationships with their customers. A method of operating an integrated mortgage advice system comprises the steps of collecting a borrower's vital data and entering the borrower's vital data into a borrower database. Selecting a plurality of mortgage products from a lender database, and using the borrower's vital data to search for the greatest available savings opportunity for the borrower within a plurality of mortgage products. The integrated mortgage advice system is activated for the borrower on a periodic basis. The system performs many tasks, including recommending the optimum time for refinance; identifying, reducing or eliminating mortgage-related expenses; and eliminating Private Mortgage Insurance in a timely fashion.

### FIELD OF THE INVENTION

The present invention relates generally to computer based advisory systems for the mortgage industry, and more specifically, the invention is a computer based system for providing mortgage-based financial advice relative to a Borrower's mortgage

### BACKGROUND OF THE INVENTION

For most Americans, their home is the largest investment they will ever make, and often their largest monthly expense. All Borrowers have a mortgage strategy, but these strategies range from proactive analysis, to apathy, to ad-hoc decisions. Mortgage industry marketing reports suggest that many Borrowers take action when a telemarketer calls. Borrowers can call a Mortgage Professional, such as a banker or mortgage broker, for advice, but this generally doesn't happen on a regular basis. Mortgage Professionals can call their Clients, the Borrowers, and offer analysis but this isn't typical either. Clients are defined as Borrowers who have done business with the Mortgage Professional.

The average American Borrower makes a new mortgage every 7 years. Traditionally, Mortgage Professionals spend a significant amount of resources trying to obtain and identify new Borrowers. Mortgage Professionals also spend a significant amount of money on phone directory advertising, advertising in newspapers and periodicals, direct mail to potential customers, cold calls and telemarketing. Industry experts estimate the cost of obtaining new customers is about ten times the amount required to retain a customer. Mortgage Professionals could save a lot of money and time by contacting Borrowers who are already customers. The process could be greatly improved and streamlined if the Mortgage Professionals knew the conditions of the previous mortgage and the Mortgage Professional understood the Borrower's home ownership goals.

After a Borrower closes a loan, most Mortgage Professionals generally have little, if any, further contact with the Borrower. This greatly reduces the chance for any repeat business. It is well known that it is much cheaper to maintain a business relationship than to spend resources acquiring new business. To achieve maximum success, Mortgage Professionals need a system that securely stores Borrower mortgage information and proactively analyzes that information on a regular basis to provide custom, integrated mortgage related advice that is specific to each Borrower. An integrated mortgage advice system would be a boon to both Mortgage Professionals and Borrowers.

Borrowers equipped with a proactive mortgage strategy can save a significant amount of money. However, many Borrowers make mortgage and mortgage-related decisions on an ad-hoc basis, and, as a result, many Borrowers lose money or miss favorable financial conditions. During the term of a mortgage, many variables change on a regular basis. These include, but are not limited to, interest rates, borrower's credit rating, expected term of residence, income, and loan-to-value ratio. Although a Borrower might save money by taking action, large fees, both transactional and hidden, make mortgage-related decisions a minefield of potential losses for the Borrower. Sometimes it makes sense to pay the large transaction fees associated with making a change and sometimes the “savings” won't cover the cost of the transaction within the scope of the home ownership plan of the Borrower. Only a careful analysis of changing circumstances cross-referenced with a Borrower's unique situation and tolerances can protect the Borrower from spending needlessly.

Unfortunately, measuring and calculating the variables of mortgage and mortgage-related decisions can be a daunting task, even for a seasoned Mortgage Professional. As a result, most Borrowers don't inventory their mortgage situation on a regular basis. Although the best solutions aren't always easy to find, every savvy Borrower and Mortgage Professional knows: a wise and proactive mortgage strategy can save the Borrower thousands of dollars. Thus, what is needed is an integrated mortgage system that links a Borrower, a Lender who makes a mortgage, and a Mortgage Professional to provide a wide variety of customized, periodic, post-closing customer-care services.

### SUMMARY OF THE INVENTION

An integrated mortgage advice system provides an integrated solution to these two problems: the need for periodic post-close customer care for and from Mortgage Professionals, and the need for sound financial advice for Borrowers. The System, or the sum total of all components of an integrated mortgage advice system, provides services and tools to provide post-close customer care for the Mortgage Professional's Borrowers. In addition, the system predicts when Private Mortgage Insurance PMI cancellation eligibility is imminent, including a reminder of when eligibility of cancellation is imminent; advice on administration of the cancellation process; and ultimately: timely, hassle-free Mortgage Insurance cancellation. The System provides resources to help the Borrower and Mortgage Professional estimate the market value of the Property, defined as any real property usually real estate. The System also provides proactive rate monitoring and circumstance-comparison to alert Borrowers and Mortgage Professionals of beneficial refinance opportunities. Finally, the system identifies other mortgage-related savings, for example, a reduction in rate due to an improvement in the Borrower's credit score.

A Borrower who finances more than 80% of the value of his homes is required to pay Private Mortgage Insurance (PMI). Equity grows through payment of principal, improvements to property, and growth in market value. Federal law mandates that on loans made on or after Jul. 29, 1999 PMI ends automatically after the principal is paid down to 78 percent of the original appraised value of the house.

However, most consumers qualify for PMI elimination much sooner than the above stated provision allows, and sooner than they realize. This is because equity grows through growth in the market value of the property much more quickly than through the payment of principal. By measuring and estimating these factors, the system can predict when a Borrower is eligible for PMI cancellation. The System can remind the Borrower when this date is imminent and then can provide advice to help with administration of PMI cancellation.

The system proactively monitors current mortgage market conditions to recommend the best time for refinance. When the Borrower decides to refinance, an integrated mortgage advice system can evaluate all the many permutations to determine whether the Borrower's interests would be better served by an adjustable or fixed rate loan based on the lowest after tax interest costs.

The System provides the Borrower with sophisticated data modeling based on the Borrower's own unique circumstances, taking into account national, regional, and local financial and tax issues. This empowers the Borrower to structure his debt in the way that is most advantageous to the Borrower, instead of a one-size-fits-all solution to the borrower's unique circumstances. In a simple and easy to understand format, the Borrower will have answers to questions like: “To get cash-back, should I secure a second mortgage or should I refinance my first mortgage?”

The System may recommend that a customer pay weekly, biweekly or monthly payments. The System can help structure these payments to allow for an early pay-off of the loan. At any point during the loan, an integrated mortgage advice system can help the Borrower change his/her payment options to suit his current lifestyle.

There are four types of users who may interface with the system: 1) administrators, who run the system; 2) originators, the mortgage professionals, bankers, brokers, retailers, etc.; 3) clients, the borrowers or other people who need the data analysis; and 4) lenders, these are the banks who create the mortgage products the system analyzes.

Administrators will need hardware, software and some staff to operate the system. Although the Administrator runs the servers, the required hardware is not specialized. The current system administrator operates a server that supports approximately one thousand originators, expecting fifty to one hundred concurrent users at any given time. The server has a 30 gigabyte hard-drive, two 1 gigabyte processors with about a half a gigabyte of memory. Optimally, the server should have a redundant power supply, a back-up system, and a gigabit Ethernet network connection. However, any bank of servers with nearly any operating system, including Microsoft, Oracle or Linux, will suffice, provided the hardware is scaled to the size of the database the administrator plans to analyze and service.

The Administrator will also need software to support the operation of the system, including an operating system and a database. The current administrator operates a server that functions on Windows 2000 Server with SQL Server 2000 database. The data analysis and integration function of the invention is performed by a proprietary software application. The current application was written in Powerbuilder for a Windows Operating System, but the logic could be migrated into other languages. Much of the logic of this software is detailed in this document. Furthermore the application itself can function in some other environments. For example, the current application could work on a Citrix Server. The Administrator's staff may perform the physical labor of stuffing envelopes and operating the system, or that process may be automated.

The originators will also need hardware and software to interface with the system. The originator will need a computer with network access to the Administrator's server or a computer with the ability to accept and create physical media, i.e. CD-ROMs, ZIP-drives, data tapes, etc. Currently the system is geared toward supporting commercially available and widely distributed Windows-based PC's with standard, or better, hardware, for example a Pentium 2 processor with 180K of RAM, 10 GB hard drive, etc. A 28.8k baud rate modem is recommended as a minimum network connection. Local data storage can be performed by any one of many widely available mortgage origination tools, or by personal database tools such as MS Access. However, the system is much easier to maintain and operate if the originator installs and uses the proprietary MortgageWise software. This software interfaces directly with the server application and provides redundant data storage, data analysis and data integration on a local machine. Much of the logic of this software is detailed in this document.

Clients, or borrowers, do not need any software or hardware to use this system, provided they are dealing with an originating mortgage professional, broker, banker or retailer. Clients simply provide data to the originator and the system replies with timely analysis. Clients can deal directly with the Administrator by using the originator software described above, and if this is the case, the client will need a similarly equipped machine. Additionally, clients who have Internet access can use a web application to enter data and to perform analysis. To operate the Internet application, the client will need a browser capable of reading HTML over the World Wide Web.

Lenders do not need any software or hardware to use this system. Lender data is maintained by the administrator or by the originators. However, lenders who wish to maintain their own data will need a computer with network access to the Administrator's server or a computer with the ability to accept and create physical media, i.e. CD-ROM's, ZIP-drives, data tapes, etc. Currently the system is geared toward supporting commercially available and widely distributed Windows-based PC's with standard, or better, hardware, for example a Pentium 2 processor with 180K of RAM, 10 GB hard drive, etc. A 28.8k baud rate modem is recommended as a minimum network connection. Local data storage can be performed by any one of many widely available mortgage origination tools, or by personal database tools such as MS Access. However, the system is much easier to maintain and operate if the lender installs and uses the proprietary MortgageWise software. This software interfaces directly with the server application and provides redundant data storage, data analysis and data integration on a local machine. Much of the logic of this software is detailed in this document.

### BRIEF DESCRIPTION OF THE DRAWINGS

FIG. 1 is a block diagram showing the configuration of an integrated mortgage advice system according to the present invention.

FIG. 2 is a block diagram showing the configuration of the input methods into a Borrower Database System according to the present invention.

FIG. 3 is a block diagram showing the configuration of input methods into the Lender Database System according to the present invention.

FIG. 4 is a block diagram showing the relationship between a plurality of databases within an integrated mortgage advice system.

FIG. 5 is a block diagram showing a variety of data management and data analysis services within an integrated mortgage advice system.

FIG. 6 is a flowchart showing a procedure for maintaining a local database within an integrated mortgage advice system.

FIG. 7 is a flowchart showing a procedure for updating data to and from a remote database and to and from a local database within an integrated mortgage advice system.

FIG. 8 is a flowchart showing how a procedure for overwriting a local database with a remote database within an integrated mortgage advice system.

FIG. 9 is a flowchart showing a procedure for proactively analyzing refinance opportunities for a Borrower within an integrated mortgage advice system.

FIG. 10 is a flowchart showing a procedure for proactively analyzing mortgage insurance data for a Borrower within an integrated mortgage advice system.

FIG. 11 is a flowchart showing a procedure for consolidating loan information for a Borrower within an integrated mortgage advice system.

FIG. 12 is a flowchart showing a procedure for analyzing the benefits and costs of payment options for the Borrower within an integrated mortgage advice system.

FIGS. 13-16 are flowcharts showing how an integrated mortgage advice system triggers to contact a Borrower within an integrated mortgage advice system.

FIG. 17 is a flowchart showing a procedure for contacting a Borrower within an integrated mortgage advice system.

### DETAILED DESCRIPTION OF THE DRAWINGS

During a Borrower's term of ownership of property, mortgage rates may rise or fall, or both. These fluctuations generate savings opportunities for the savvy Borrower. However, just because rates fall doesn't mean it's time to refinance, and just because rates rise doesn't mean the Borrower would not benefit from a refinance.

The System proactively monitors current conditions on a periodic basis to determine favorable times for refinancing. When the decision to refinance is made, the system can evaluate choices to determine whether the Borrower's interests would be better served by an adjustable or fixed rate loan-potentially saving the mortgagor tens of thousands of dollars.

By the same token, when it's time to take cash from equity, the system can calculate what's best for the Borrower. In some situations, a second mortgage is the best choice, for others, refinancing is the money-saving option. There is no reason for a Borrower to take chances: the system can select the safest path from the myriad of choices.

The System provides the Borrower with sophisticated data modeling based on his own unique circumstances. This empowers the Borrower to structure debt in the way that is most advantageous to the mortgagor. In a simple, easy to understand format, the Borrower will have the answer to questions like: “To get cash-back, should I start a second mortgage or should I refinance my first mortgage?”

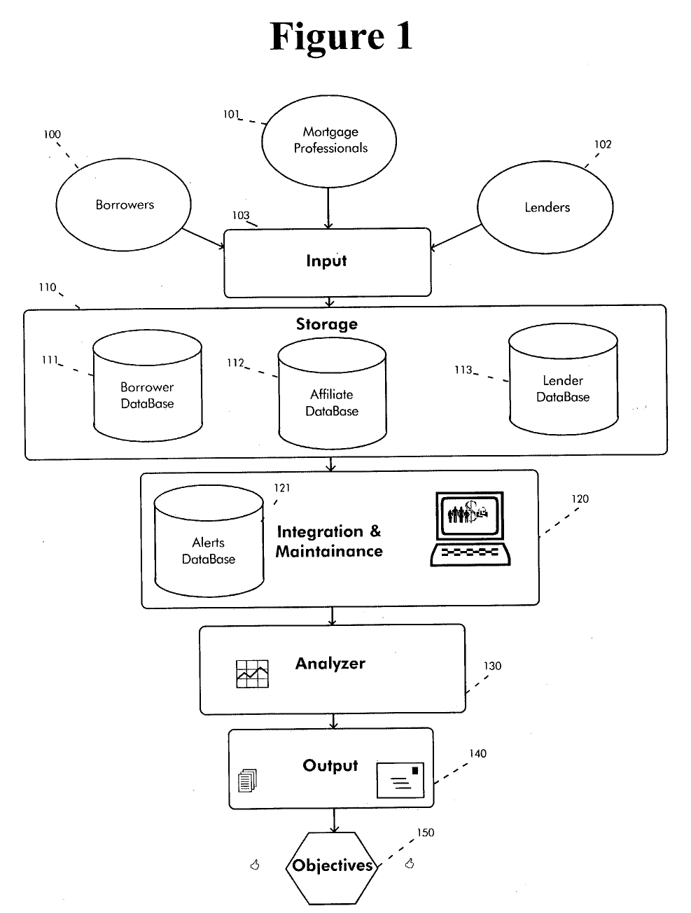

FIG. 1 is a block diagram showing the configuration of the integrated mortgage advice system according to the present invention.

Each Borrower 100 has his own unique Vital Data, which includes, but is not limited to: contact information for the Borrower 100; legal description of the Borrower's Property; terms of the loan rate, points, period, etc.; Private Mortgage Insurer/Government Mortgage Insurer information and premiums; estimated market growth including inflation; authorization for an Administrator, the entity that services and sells the Invention, to analyze Borrower's data with the system; Borrower's Insurance information; Borrower's ownership plan i.e. how long the Borrower 100 intends to own the Property; Borrower's credit rating; and any Lender 102 and account information. The Vital Data is essentially an inventory of all of the facts pertinent to a Borrower's mortgage.

A Retailer is a User who sells an integrated mortgage advice system to Borrowers 100. The Retailer forwards Vital Data about the Property and Borrower to the Administrator. The Retailer is kept apprised of all customer contact the system provides. Each time an Alert is sent to a Borrower, a similar contact is summarized and sent to the Retailer. A User may be any entity, Mortgage Professional 101, Borrower 100, Manager or other party using the System. Most often Retailers and Mortgage Professionals 101 need to interface with both the Borrower 100 and the Lender 102, and thus they are often Users. Users have information, such as the Mortgage Professional's company, including: company name and contact information; company logo and photo of Mortgage Professional 101; employee number of Mortgage Professional 101; lenders 102 who wholesale to, or broker with, the Mortgage Professional 101. In this document, an Affiliate is an entity using an integrated mortgage advice system and employing one or more Mortgage Professionals 101. This Affiliate Data is essentially an inventory of all of the facts pertinent to a Mortgage Professional 101 and his company.

A Lender 102 is an institution that actually loans the money to make the mortgage. A Lender 102 has information about the Lender 102 and its Products. A Product includes mortgages or loans. Rates, terms and fees vary from product to product. Information about the Products includes: points, discount and origination; rate, balloon specifics; equity requirements; credit requirements; term of the loan; type of loan, whether conforming, subprime, fixed, adjustable, etc.; and lending institution. Lender Data contains of all of the facts and specifics relevant to the costs, benefits and requirements of any mortgage in the database.

The data input system 103 enables information from a variety of unconnected sources with variable technology systems, such as borrowers 100, mortgage professionals 101, and lenders 102, to be collected into the system.

A data storage system 110 warehouses input from the data input system 103. Data within the data storage system 110 can be stored in a plurality of databases including the Borrower Database 111, the Affiliate Database 112, and the Lender Database 113.

An integration and maintenance processor 120 operates the plurality of databases, and sends this information to an analyzer 130, to produce an output 140. Integrated data that is calculated from information in data Storage 110 is saved to an Alerts Database 121. The output 140 is used to provide information for Managers. A Manager is an entity in a leadership role at the Mortgage Professional's company. The output 140 also produces post-close customer care for Mortgage Professionals 101, and sound financial advice for Borrowers 100.

An objective 150 is created from the output 140. The objectives 150 include appropriately-timed, trustworthy advice that a Borrower 100 can rely on to make smart mortgage-related decisions. The integrated mortgage advice system helps the Mortgage Professional 101 to generate community goodwill, repeat business, referral business and lifetime loyalty from the borrowers 100. The integrated mortgage advice system helps a personnel manager, such as a retailer 101, track and tally employee efforts. Using data in the System, a Manager can determine how many loans his Mortgage Professionals 101 are closing and monitor all of the data related to those Borrowers 100. He can quickly aggregate that information to measure his business' productivity and success and he can also determine who is retaining business with repeat business.

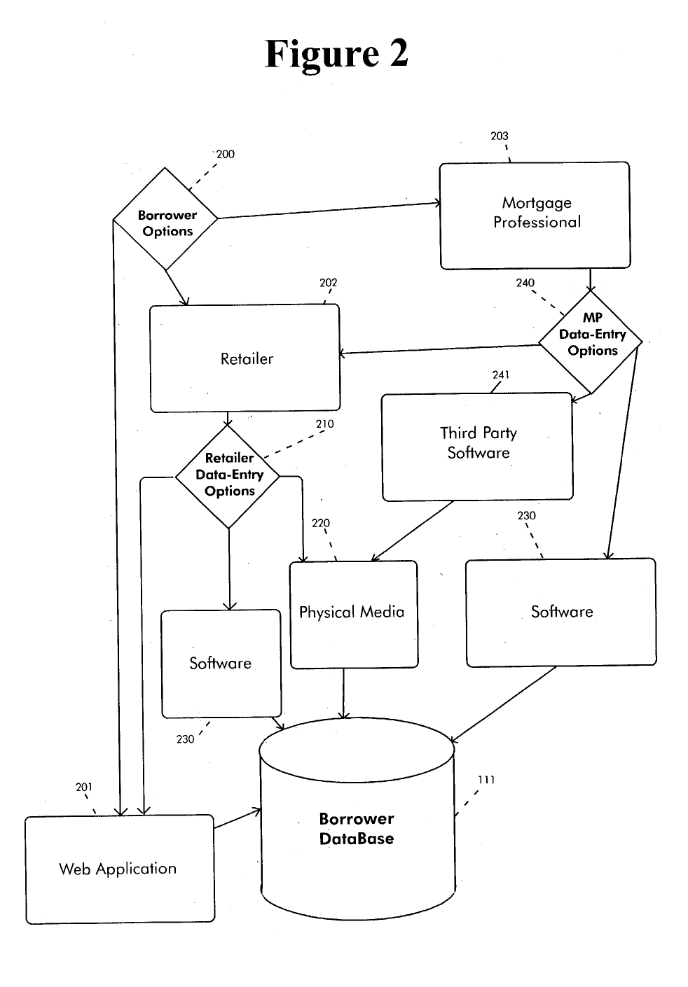

FIG. 2 is a block diagram showing the configuration of the Borrower Database 111 according to the present invention. Borrower data exists in a myriad of formats and disjoined sources. Borrowers 100 are presented with their data entry choices at borrower options 200. Borrowers 100 can enter their data through any of the available channels. FIG. 2 shows that the Borrower 100 can use a web-application 201 to enter data into the borrower database 111. Alternatively, the Borrower 100 can provide his Vital Data via a System Retailer 202, or via a Mortgage Professional 203.

When a Borrower 100 purchases an integrated mortgage advice system's service directly from the Administrator, the Borrower enters his data via a web-enabled software, or Web Application 201. The Web Application 201 may be delivered over the Internet to the Borrower's 100 web browser. Borrower Data from the Web Application 201 can be inserted directly into the Borrower Database 111. The term Software refers to a network-ready software application that performs many aspects of the system. The Web Application 201 is a component of that Software.

If the Borrower 100 purchases integrated mortgage advice system services from a Retailer 202, the Retailer 202 must enter the data into the Borrower Database 111. The retailer 202 has several options 210 for entering data into the Borrower Database 111. The Retailer 202 can interview the Borrower 100 and then enter data into a web-enabled data entry subsystem, or web application 201. Alternatively, the Retailer 202 can save the data onto a Physical Media 220. Physical Media 220 can be any physical, portable data device such as a CD, portable hard-drive, data disk or other format. The Physical Media 202 is delivered, or virtually delivered via an electronic connection, to the Borrower Database 111. Also, the retailer 202 may use a PC-enabled Software 230 that the Retailer 202 can use to enter data from the Borrower 100 interview into the Borrower Database 111.

If the Borrower 100 is doing business with a Mortgage Professional 203, that Mortgage Professional 203 is already collecting most of the information that is required by an integrated mortgage advice system. The Mortgage Professional 203 collects any extra data required by the System and then chooses a data entry option 240. First, the Mortgage Professional 203 can hand the data over to a Retailer 202 who will enter the data for the Mortgage Professional 203.

Second, the Mortgage Professional 203 may have third-party mortgage-origination software, or Third Party Software 241, which he can use to input data. Data from the Third-Party Software 241 can be stored to Physical Media 220 and transferred to the borrower database 111. Lastly, the Mortgage Professional 203 can use the software 230 to enter data. The software 230 transfers data to the Borrower Database 111.

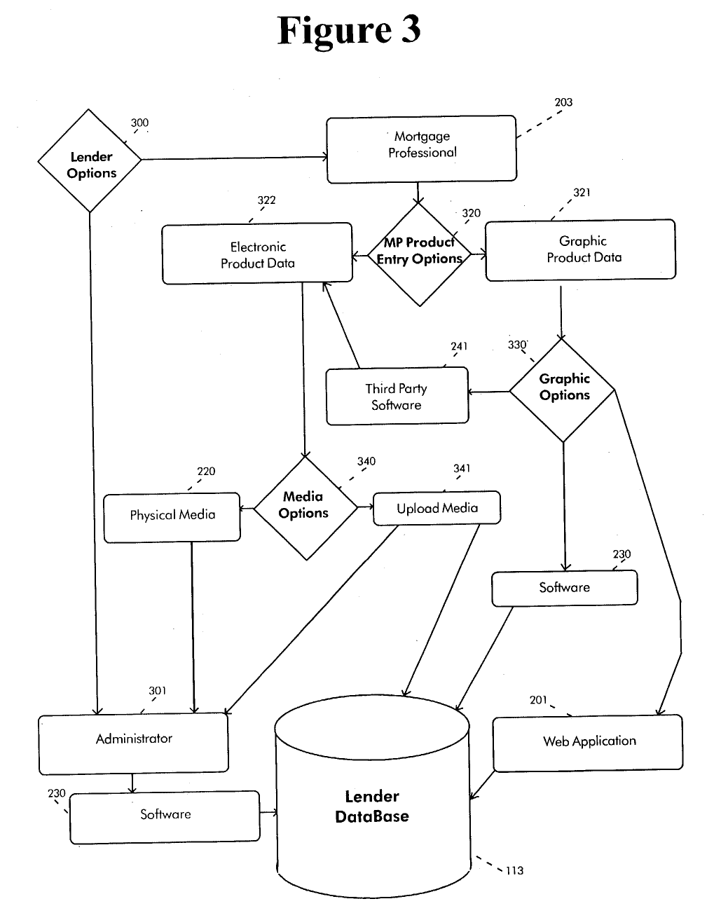

FIG. 3 is a block diagram showing the configuration of input methods into the Lender Database 113 according to the present invention. Lenders 102 are presented with their data entry options at lender options 300. There are two primary routes for product data to enter the system lender database 113. First, the Lender 102 can provide the data directly to an Administrator 301. If the Lender 102 provides the data to the Administrator 301, the raw data can be processed by the Software 230 which then inserts the data directly into the Lender Database 113. Alternatively, the Lender 102 can provide a Mortgage Professional 203 with data about the products. The mortgage professional 203 finds his data entry choices at Mortgage Professional entry options 320. There are two primary ways this data can be delivered from the Mortgage Professional 203.

First, the data can be written, faxed or in another “hard-copy” format. If so, it is called Graphic Product Data 321. Alternatively, the data can be delivered in digitized electronic format, called Electronic Product Data 322.

If the Graphic Product Data 321 is chosen, there are several graphic options 330. The Mortgage Professional 203 may enter the Graphic Product Data 321 into a Third-Party Software 241 which converts the data into Electronic Product Data 322. Alternatively, the Mortgage Professional 203 could opt to enter the Graphic Product Data 321 into the Software 230, and the Software 230 then enters the graphic product data 321 into the Lender Database 113. As a third option, the Mortgage Professional 203 could opt to enter the Graphic Product Data 321 into a Web Application 201. The Web Application 201 then enters the graphic product data 321 into the Lender Database 113.

When the graphic product data 321 is in the format of Electronic Product Data 322, the User has media options 340 for entering the information into System. The Electronic Product Data 322 is saved to Physical Media 220 or saved as Upload Media 341. Physical Media 220 is delivered to the Administrator 301, and the Administrator 301 enters the data into the Lender Database 113 via the software 230. The Upload Media 341 may enter the lender database 113 directly, or it may be delivered to the Administrator 301 electronically and then inserted into the Lender Database 113.

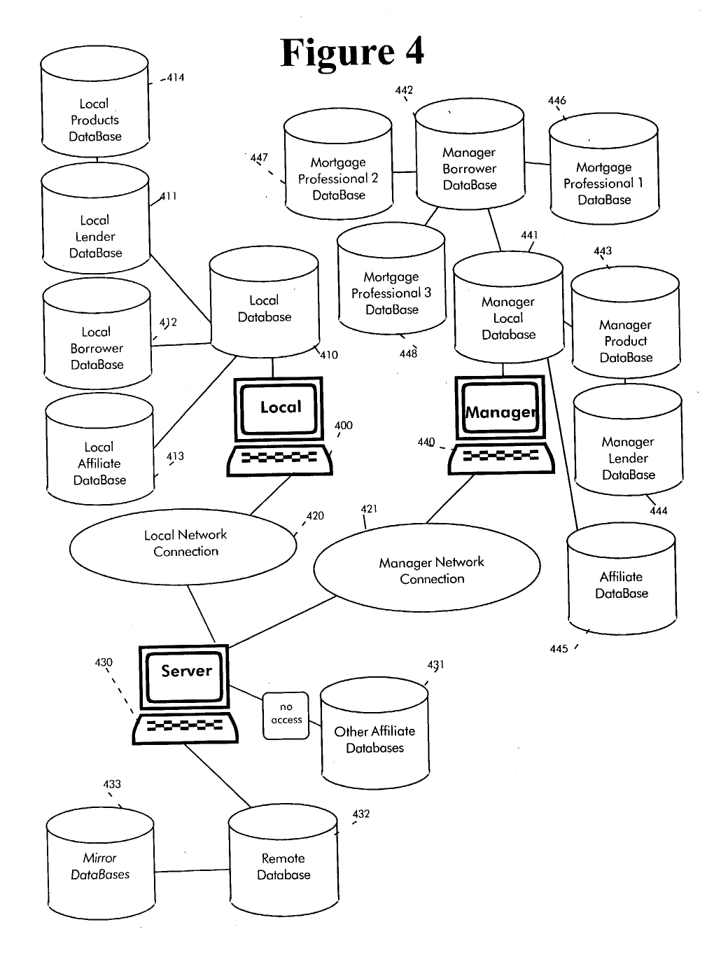

FIG. 4 is a block diagram showing the relationship between a plurality of databases within an integrated mortgage advice system. Data is stored redundantly in a number of locations to reduce the chance for data loss and to speed data processing. Each Mortgage Professional 203 or Retailer can install the Software 230 onto his local machine 400. The local machine 400 stores a Local Database 410 which contains all the files the User needs to perform data analysis, integration, storage and management.

There are a plurality of databases in the Local Database 410. These may include a Local Lender Database 411, Local Borrower Database 412 and Local Affiliate Database 413. The Local Affiliate Database 413 contains only information about the Mortgage Professional's employer and the Mortgage Professional's data. The Local Borrower Database 412 contains only Vital Data about Clients, or Borrowers 100 of the Mortgage Professional 203 relevant to the local machine 400. The Local Product Database 414 is a compilation of all of the Products offered by the Lenders 102 found in the Local Lender Database 411.

The Mortgage Professional's local machine 400 is connected via a Local Network Connection 420 to an Administrator's Server 430. Although the Server 430 contains other data about many Affiliates in the Other Affiliate Database 431, the Mortgage Professional 203 has no access to this data. The Mortgage Professional's Local Database 410 together with all the data from his Affiliate is saved in a Remote Database 432 that is linked to the server 430. The Remote Database 432 then mirrors the structure of all databases in the Affiliate within the Mirror Databases 433.

A manager 440 has a similar data structure to a Mortgage Professional 203. The Manager 440 stores his data in the Manager Local Database 441. The Manager 440 has data about his client stored the Manager Borrower Database 442. While each Client's data is unique, the lender, affiliate and product data is constant across an Affiliate. Therefore, the Manager Product Database 443, Manager Lender Database 444, and the Manager Affiliate Database 445, mirror information found in the Local Lender Database 411 and the Local Product Database 414. In addition to all of his personal files, the Manager 440 may have a duplicate of the Local Database 410 at the Mortgage Professional 1 Database 446. Additionally, the Manager 440 may have duplicates of all of his employee's local databases at databases like Mortgage Professional 2 Database 447 and Mortgage Professional 3 Database 448. Because the manager 440 has access to the Mortgage Professionals' databases, he can run reports and track and tally the efforts of his employees. Other Mortgage Professionals 203 employed at the same Affiliate would have identical data structures to those found on the Local machine 400.

Although employees at an affiliate do not share borrower data, Affiliate members may share data in the local Products database 414. When a network connection is opened, data is exchanged and all Affiliated Mortgage Professionals 203 are updated as needed.

There is no direct connection between the local machines 400 and the manager's computer 440. Instead, all data is transferred via the Manager Network Connection 421 to the Server 430 and stored in the Remote Database 432. The Remote Database 432 has a mirror of all databases and files so that in the event of a local database or remote database fails, the data can be transferred back to the machine where the data-loss occurred.

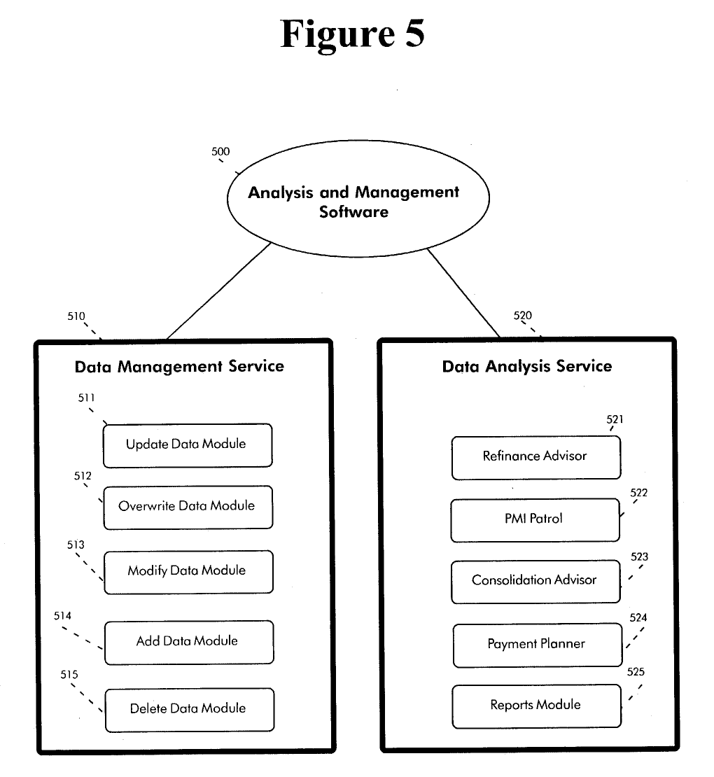

FIG. 5 is a block diagram showing a plurality of functions within an integrated mortgage advice system. The Analysis and Management Software 500 can be web-enabled, such as the Web Application 201, or PC-based, such as the Software 230, depending on how the client was retailed and what access the client possesses. The Analysis and Management Software 500 integrates the data stored in various databases, and automates the process of synchronizing local and remote data, and ensures that unauthorized personnel cannot access system data. The Analysis and Management Software 500 encompasses a plurality of services including: Data Management Service 510 and Data Analysis Service 520. The Data Management Service 510 allows Users to update data 511, overwrite data 512, modify data 513, add data 514, and delete data 515.

The Data Analysis Service 520 may be used to proactively analyze data and make recommendations as needed. The Refinance Advisor 521 helps calculate if a refinance is a smart move for a specific Borrower 100 at that time and helps select the best product for that refinance. PMI Patrol 522 predicts when mortgage insurance cancellation is imminent. The Consolidation Advisor 523 calculates the best product for loan consolidation and the Payment Planner 524 calculates the effects of different payment options. The Data Analysis Service 520 can also produce Reports 525, which may be used to query and calculate information from a database to provide important information to Mortgage Professionals 101, Managers 440, Retailers 101 and Borrowers 100.

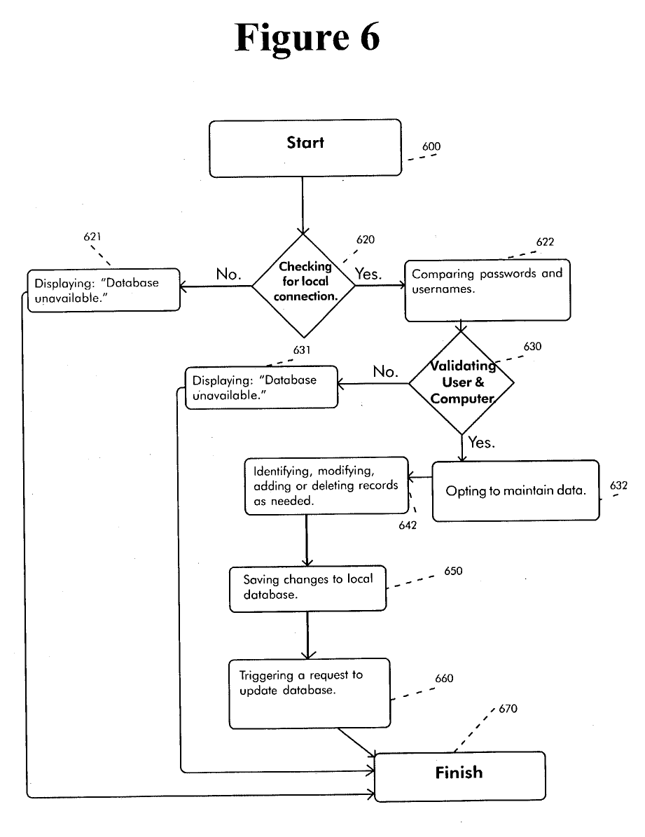

FIG. 6 is a flowchart showing a procedure for maintaining a local database within an integrated mortgage advice system. The User starts the process, step 620, when the system checks for a connection to the local database. If the system cannot establish a connection, the system displays “Database unavailable” at step 621. Helpful error messages may also be displayed. This ends the process, step 670. If the database is found, the Software then compares encrypted key codes and passwords with records already on file, step 622. Next, the system attempts to validate the user and his computer, step 630. If the User cannot be validated, the system displays “Database unavailable”, step 631. This ends the process at step 670. If the user can be validated, the system validates the user and his machine, step 630. Once the system has validated the user, the user opts to maintain data, step 632. The process of data maintenance includes adding, deleting, or modifying records the user can identify, search, view, modify, add or delete records as needed, step 642.

When the User is finished, changes are saved to the local database 650. As the program is exited, the system will prompt the User to update the remote database 660. If the remote database is not updated at that time, the system will remind the User to update data the next time the program is opened. This ends the process, step 670. In the event the User is using the web-application there is usually no local database and the User simply modifies the remote database.

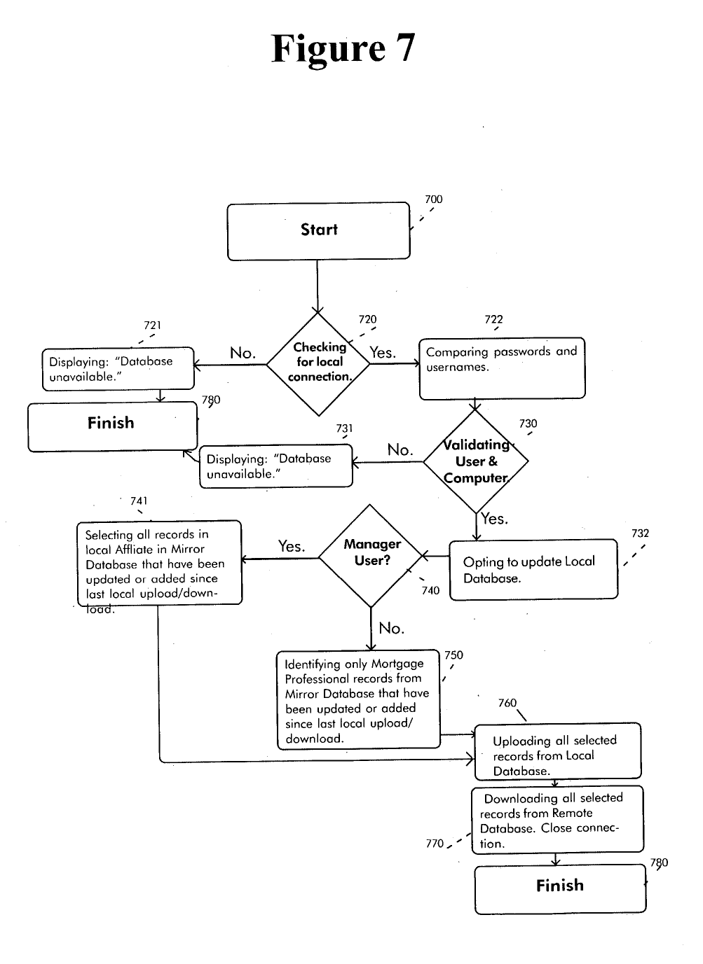

FIG. 7 is a flowchart showing a procedure for updating data to and from a remote database, and to and from a local database within an integrated mortgage advice system. The process starts, step 700, when the system checks for a connection to the local database, step 720. If the system cannot establish a connection, the system displays “Database unavailable” at step 721. Helpful error messages may also be displayed. This ends the process, step 780. If the database is found, the system then compares encrypted key codes and passwords with records already on file, step 722. Next, the system attempts to validate the user and his computer, step 730. If the User cannot be validated, the system displays “Database unavailable”, step 731. This ends the process at step 780. If the user can be validated, the system validates the user and his machine, step 730. Next, the user opts to update his Local Database, step 732. The system determines whether or not the User is a Manager, step 740. If the user is a Manager, the system selects all records from the Manager's Affiliate that have been updated or added since the last upload or download, step 741.

If the User is not a Manager, the system selects only those records that are permitted to that User, step 750. For example, permitted data includes new Product updates or that User's Borrower Data. Next, the system uploads selected records from the Local Database 760. The system then downloads all new or modified records from the Remote Database, step 770, to finish the procedure at step 780.

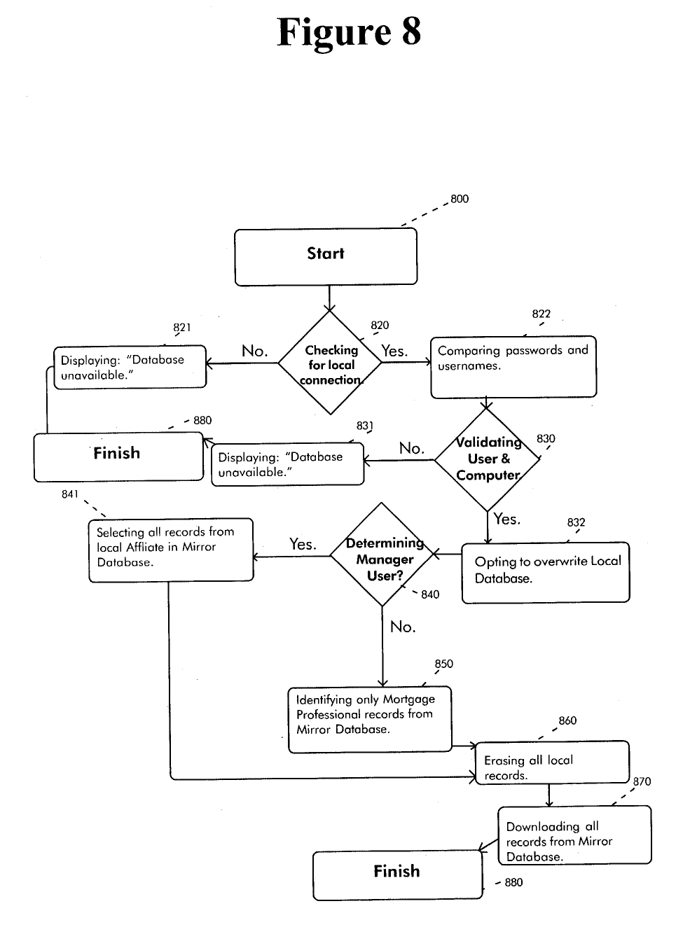

FIG. 8 is a flowchart showing a procedure for overwriting a local database with a remote database within an integrated mortgage advice system. From time to time, the local database can become corrupt or data may be lost. The overwriting procedure starts, step 800, when the system checks for a connection to the local database, step 820. If the system cannot establish a connection, the system displays “Database unavailable” at step 821. Helpful error messages may also be displayed. This ends the process, step 880. If the database is found, the system then compares encrypted key codes and passwords with records already on file, step 822. Next, the system attempts to validate the user and his computer, step 830. If the User cannot be validated, the system displays “Database unavailable”, step 831. This ends the process at step 880.

If the user can be validated, the system validates the user and his machine, step 830. Next, the user opts to overwrite his local database, step 832. The system determines whether or not the User is a Manager, step 840. If the user is a Manager, the system identifies and selects all records from the Manager's Affiliate, step 841. If the User is not a Manager, the system selects only those records from the mirror database that are permitted to that User, step 850. For example, permitted data includes new Product updates or that User's Borrower Data.

The system then erases all local records at step 860, and downloads all records from the Remote Database, step 870, to finish the procedure at step 880.

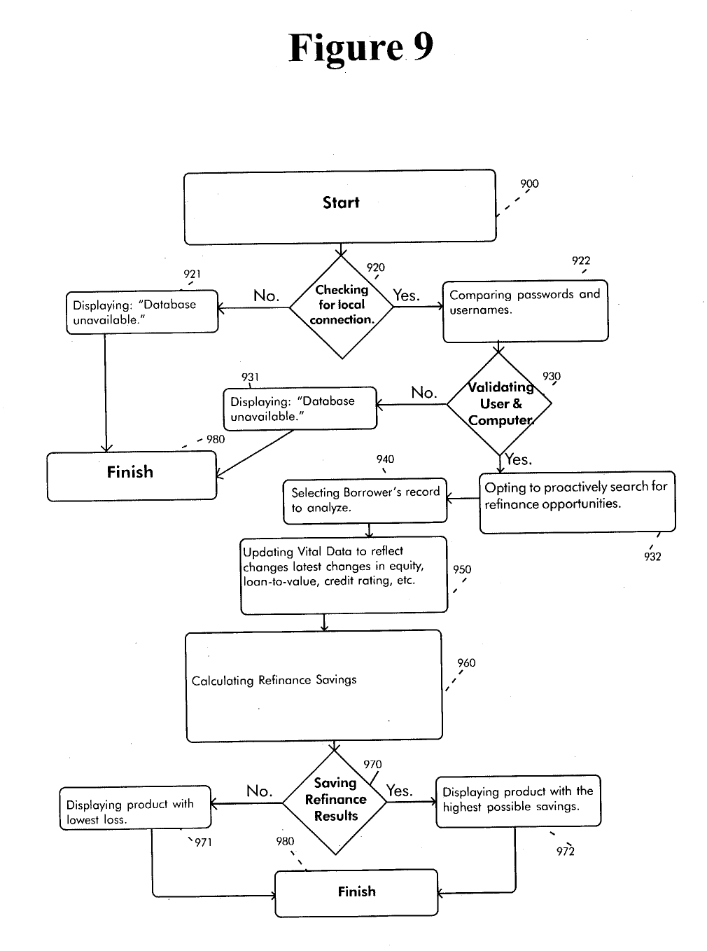

FIG. 9 is a flowchart showing a procedure for proactively analyzing refinance opportunities for a Borrower within an integrated mortgage advice system. This process starts, step 900, when the system checks for a connection to the local database, step 920. If the system cannot establish a connection, the system displays “Database unavailable”, step 921. Helpful error messages may also be displayed. This ends the process, step 980. If the database is found, the system then compares encrypted key codes and passwords with records already on file, step 922. Next, the system attempts to validate the user and his computer, step 930. If the User cannot be validated, the system displays “Database unavailable”, step 931, ending the process, step 980.

If the system has validated the User and his computer, step 930, the user opts to check for refinance savings, step 932, based on the latest available data. Any savings is based purely upon the unique financial conditions of the market and a borrower. The user selects a Borrower's record for analysis, step 940. The User may select only from those Borrowers that are on the Local Database where Vital Data for the User's Clients are housed. This system prevents Users from accessing data that they do not have permission to view. The User then updates any information that has changed about the selected Borrower at step 950.

Next, the system then calculates refinance savings, step 960. This calculation typically takes into account several factors, including: the remaining number of months the borrower expects to own the property, but not more than the term of the current loan; new monthly payment; old monthly payment; monthly savings; and the cost of the transaction. The system checks each product available to the User and saves the answers at step 970. If the system finds no savings opportunity, the system displays the Product, and associated Lender, with the lowest cost at step 971, ending the process, step 980. If the system finds a savings opportunity, the system displays the product with the highest possible savings, step 972. This ends the process at step 980.

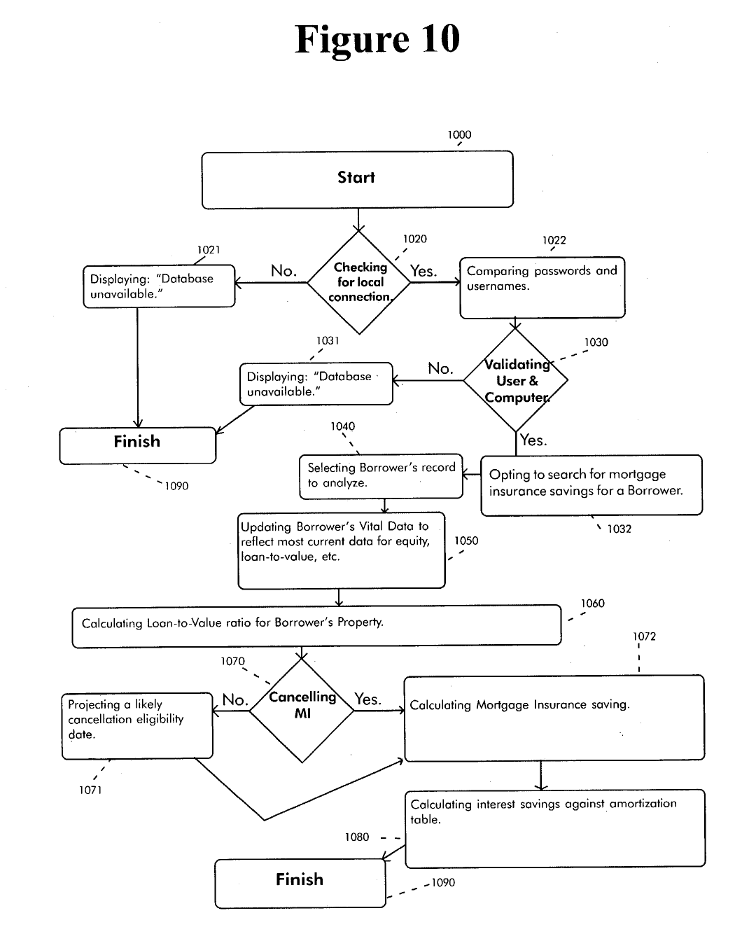

FIG. 10 is a flowchart showing a procedure for proactively analyzing mortgage insurance data for a Borrower within an integrated mortgage advice system. The system can be used to predict mortgage insurance cancellation dates and calculate the amount of money that can be saved by prompt cancellation of the mortgage insurance.

The process starts, step 1000, with the system checking for a connection to the local database, step 1020. If the system cannot establish a connection, the system displays “Database unavailable” at step 1021. Helpful error messages may be displayed. This ends the process at step 1090.

If the database is found, the system compares encrypted key codes and passwords with records already on file, step 1022. Next, the system attempts to validate the user and his computer, step 1030. If the User cannot be validated, step 1030, the system displays “Database unavailable” at step 1031, ending the process at step 1090.

If the User can be validated, the user opts to search for refinance savings for a borrower, step 1032, based on the latest available data. Next, the user may select a Borrower's record for analysis, step 1040. The User may select only from those Borrowers that are on the Local Database where Vital Data for the User's Clients is housed. The system prevents Users from accessing data that they do not have permission to view. The User then updates any information that has changed about the selected Borrower, step 1050.

The system then calculates loan-to-value ratio for the Property comparing the most current principle-owed to the most current estimated value of the Property, step 1060. If the loan-to-value ratio is in excess of 80%, the Private Mortgage Insurance or GMI Government Mortgage Insurance, the Borrower may be eligible for mortgage insurance cancellation 1070.

If the borrower is not eligible for mortgage insurance cancellation at that time, step 1071, the system projects a likely date of cancellation based upon predicted home equity growth through pay-down of principal and through increases in market value. Once that date is calculated, the system projects savings to be had through prompt cancellation of mortgage insurance 1072.

In either case, the system then calculates mortgage insurance savings at step 1080. This calculation includes such factors as: the monthly mortgage insurance premiums; and the number of months between the projected cancellation date and the government's required cancellation date. Additionally, the system calculates how much money could be saved if the Borrower applied the mortgage insurance premium to principle on the loan, which finishes the process at step 1090.

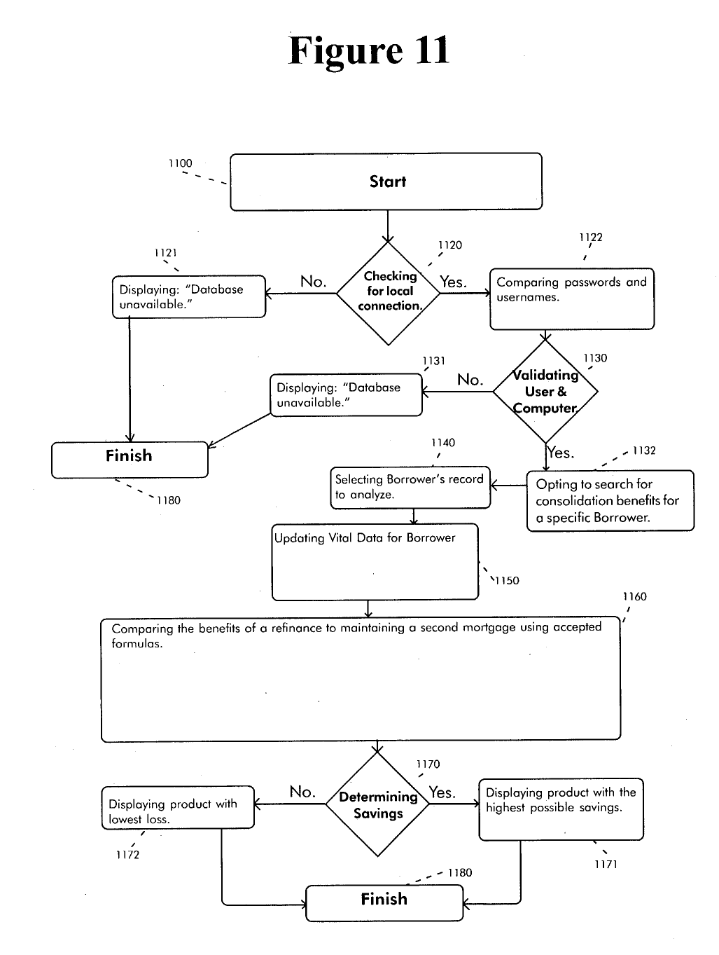

FIG. 11 is a flowchart showing a procedure for consolidating loan information for a Borrower within an integrated mortgage advice system. The consolidation advisor may be used proactively to calculate the best consolidation option for a Borrower.

The process starts, step 1100, with the system checking for a connection to the local database, step 1120. If the system cannot establish a connection, the system displays “Database unavailable”, step 1121, ending the process at step 1180. Helpful error messages may also be displayed. If the database is found, the system compares encrypted key codes and passwords with records already on file, step 1122. Next, the system attempts to validate the user and his computer, step 1130. If the User cannot be validated, the system displays “Database unavailable”, step 1131, ending the process at step 1180.

If the system has validated the User and his computer, step 1130, the user opts to search for loan consolidation benefits for a borrower, step 1132. Next, the user selects a Borrower's record for analysis at step 1140. The User may select only from those Borrowers that are on the Local Database where Vital Data for the User's Clients is housed. This system prevents Users from accessing data that they do not have permission to view. The User then updates any information that has changed about the selected Borrower, step 1150, including equity, credit rating, and other factors.

The system then compares the benefits of refinancing to loan consolidation, step 1160, using accepted financial formulas. The system repeats this comparison for each and every Product and permutation possible, storing the results to determine the Borrower's best option for savings, step 1170. If the Borrower cannot save money through consolidation, the Software displays the Product and Lender with the smallest loss, step 1172, ending the process at step 1180. If the Software finds a savings opportunity, the Software displays the Product with the highest possible savings, step 1171, ending the process at step 1180.

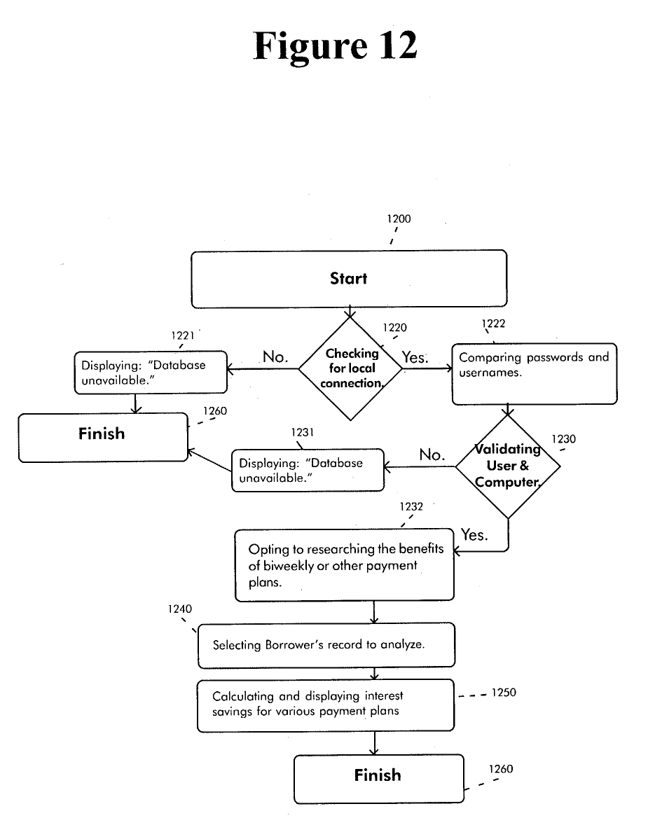

FIG. 12 is a flowchart showing a procedure for analyzing the benefits and costs of payment options for a Borrower within an integrated mortgage advice system.

The process starts, step 1200, with the system checking for a connection to the local database, step 1220. If the system cannot establish a connection, the system displays “Database unavailable”, step 1221, ending the process at step 1260. Helpful error messages may also be displayed. If the database is found, the system compares encrypted key codes and passwords with records already on file 1222. Next, the system attempts to validate the user and his computer, step 1230. If the User cannot be validated, the system displays “Database unavailable”, step 1231, ending the process at step 1260.

If the system has validated the User, step 1230, the user opts to calculate the benefits of various payment plans at step 1232. The user may select a Borrower's record to analyze, step 1240. The User may select only those Borrowers that are on the Local Database where Vital Data for the User's Clients is housed. This system prevents Users from accessing data that they do not have permission to view.

The system can enable a customer to calculate the effects of making weekly, biweekly or monthly payments, step 1250, and a Borrower can structure these payments to allow for an early pay-off of the loan. At any point during the loan, the Borrower can change payment options to suit his current lifestyle. Through careful management of payment strategy alone, a Borrower can save tens of thousands of dollars. For example, switching to biweekly payments can rapidly pay down a mortgage and at the same time improve credit rating—which may allow for increased savings through a refinance. The Payment Planner helps the User counsel the Borrower to select the payment strategy that best fits the User's budget. The procedure is finished at step 1260.

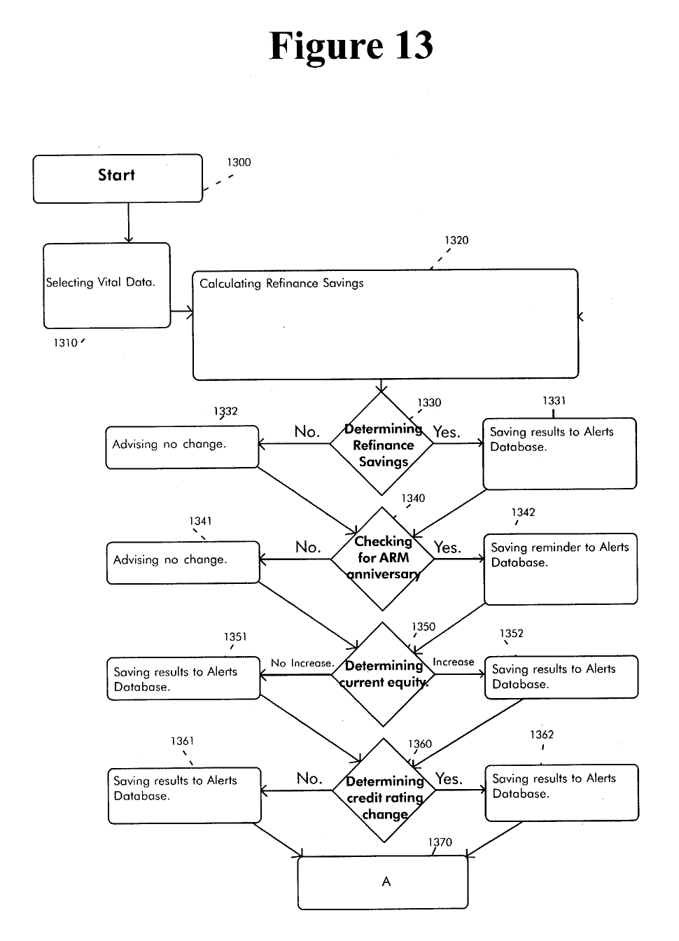

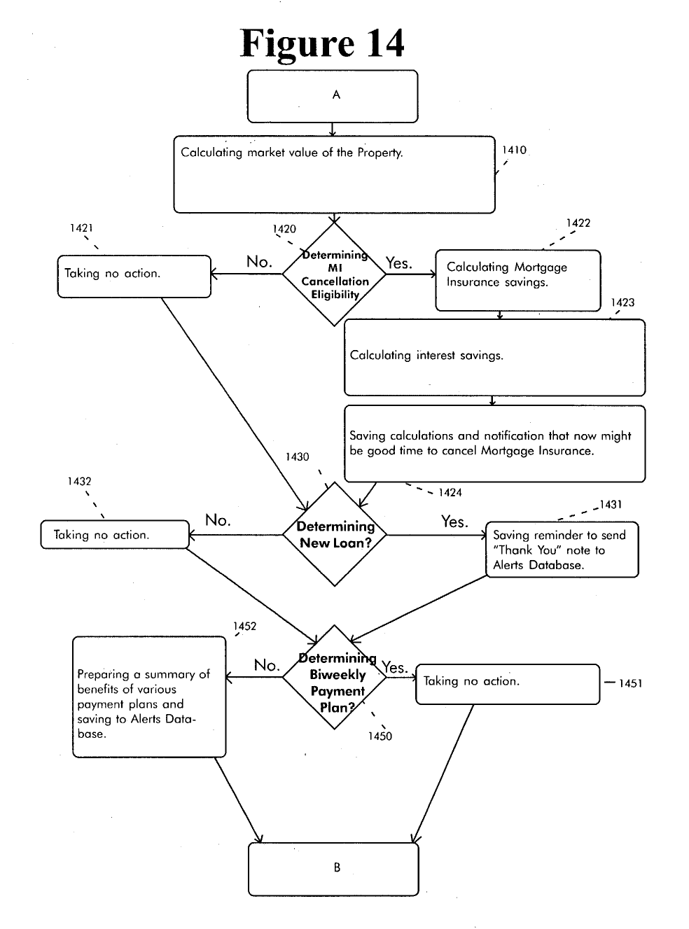

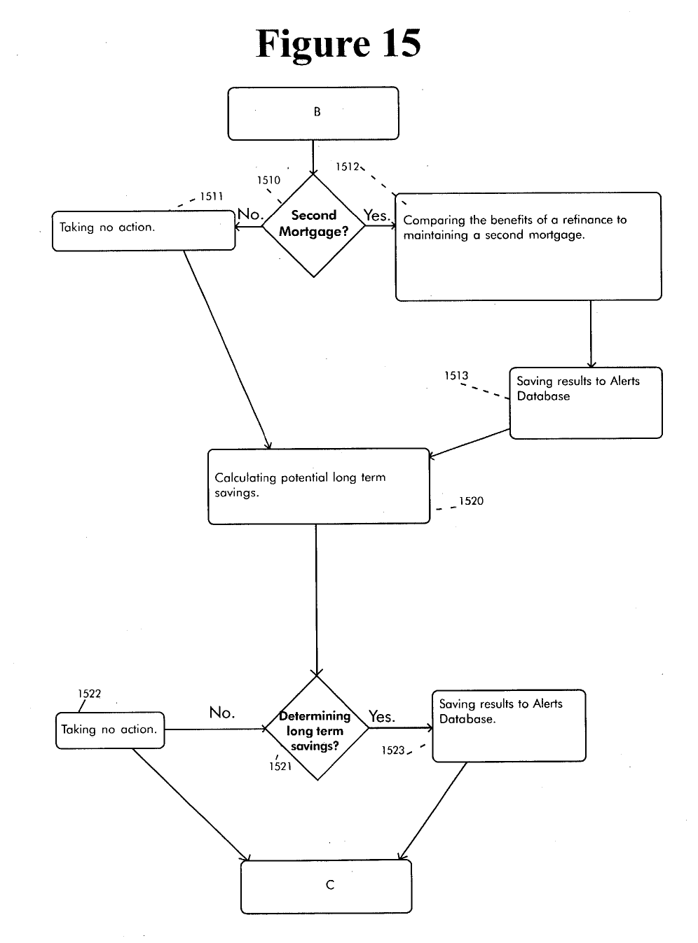

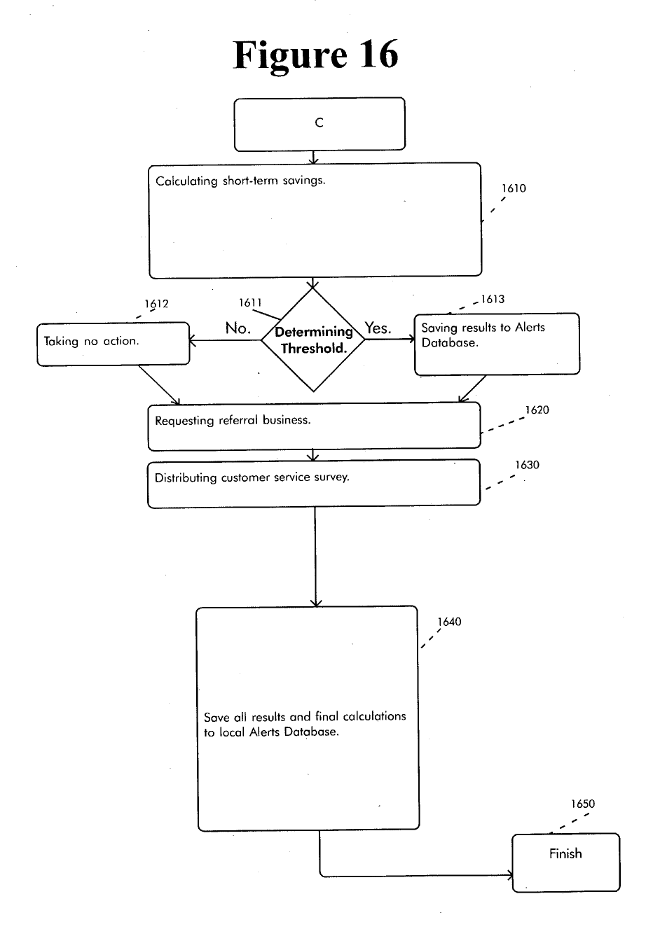

FIGS. 13-16 are flowcharts showing how an integrated mortgage advice system triggers to contact a Borrower within an integrated mortgage advice system. The Software performs these tasks for each Borrower on a periodic basis.

The system starts, step 1300, by selecting the most recent vital data from a borrower from the Vital Data Database, step 1310. At this time, the system also updates the borrower's Vital Data with the most recent available information to reflect changes in equity, credit, loan-to-value ratio, etc. The system also selects a list of generic mortgage products from the Products Database.

The system then calculates refinance savings for each Borrower with each available Product, step 1320, then determining if there are any savings, step 1330. If a Borrower can save money, his results are saved and reported, step 1331. The report suggests the best possible current mortgage product for that borrower. If there are no savings, no action is taken, and the borrower is advised accordingly, step 1332.

The system then checks to see if the Borrower's current mortgage product is an adjustable rate mortgage, and if so, whether the adjustable rate mortgage is approaching the anniversary, step 1340. If there is not an adjustable rate mortgage anniversary, no action is taken, step 1341. If there is an adjustable rate mortgage anniversary approaching, the system prepares to notify the Borrower that now might be a good time to switch from an adjustable rate mortgage to a fixed rate mortgage, step 1342.

The system then calculates or otherwise selects the most up to date information about the current market value of the Property and Borrower's equity, step 1350. The system notifies the borrower of the current equity situation whether the equity does not go up, step 1351, or if the equity does go up, step 1352.

The system then determines, or estimates, the Borrower's latest credit rating, step 1360, and notifies the borrower of any changes or activity in the Borrower's credit file, step 1362. The borrower is also notified of no change in his credit rating at step 1361.

Next, the system calculates the Loan-to Value ratio of the Property, step 1410, to determine whether the Borrower is eligible for Private Mortgage Insurance (PMI) or Government Mortgage Insurance (GMI) cancellation, step 1420. If the Property is not eligible, or if the Property doesn't have PMI or GMI, an integrated mortgage advice system takes no action, step 1421. If PMI or GMI cancellation is imminent, the system logs the estimated cancellation date, step 1422, and then calculates the amount that could be saved in mortgage insurance premiums, step 1423. This process considers several factors, including the monthly mortgage insurance premium and the number of months remaining until the government would cancel the mortgage insurance. Next, the system calculates how much interest could be saved if the Borrower applies the value of the mortgage insurance premiums to the principle, step 1424.

The system then determines if this is the first time the Borrower has been an integrated mortgage advice system customer with this current mortgage, step 1430. If so, an integrated mortgage advice system prepares a “Thank You” notification, step 1431. If this is not the first time, then no action is taken, step 1432.

For the second and subsequent times the Borrower's mortgage goes through the process, the system determines whether the Borrower has established a biweekly payment program, step 1450. If the Borrower already has a biweekly mortgage no action is taken, step 1451. If the Borrower does not have a biweekly mortgage payment plan, the integrated mortgage advice system prepares an Alert, defined in this document as any notification sent to the Borrower by the integrated mortgage advice system, usually on behalf of a Mortgage Professional that explains the benefits of various payment plans to the Borrower, step 1452. The System enables a Borrower to select weekly, biweekly or monthly payments, and can structure these payments to allow for an early pay-off of the loan. At any point during the loan, the Borrower can change payment options to suit his current lifestyle. Through careful management of payment strategy alone, a Borrower can save tens of thousands of dollars. For example, switching to biweekly payments can rapidly pay down a mortgage and at the same time improve credit rating—which may allow for increased savings through a refinance.

For Borrowers that want to choose a date by which they will have their loan paid off, the Software can offer mortgage payment schedule options that enable the Borrower to achieve his goal.

Next, the system determines whether the Borrower has a second mortgage, step 1510. If there is no second mortgage then no action is taken, step 1511. If there is a second mortgage, then the system compares the costs of retaining two mortgages to the costs of obtaining a new product in the current market, step 1512. If the calculations suggest a savings opportunity for the borrower, the results are saved and a report is prepared for the Borrower, step 1513.

The system then checks to see if there is a Product in current product portfolio that will save the Borrower money over the long term, step 1520. This analysis considers many factors, including total monthly first and second mortgage payments, remaining number of payments, the new monthly payment with current mortgage products, the number of payments required to pay off new mortgage product, and costs of the transaction. The results are measured, step 1521, and if there are no savings to be had, the system takes no action, step 1522, but if some mortgage products do suggest potential savings, the system selects the best possible product and saves the results to send an alert to the borrower, step 1523.

Next, the system calculates short term savings for each Borrower, step 1610, comparing the current monthly payments to the monthly payments with each product currently available. Each Borrower has a preselected trigger, or a predefined set of tolerances that defines the amount of monthly savings which may cause them to take an action. Such action does not need to be in their long term interests. The system checks to see if the monthly savings exceed the preselected trigger, step 1611. If the short-term savings do not exceed that amount, then no action is taken, step 1612. If the short-term savings do exceed the triggering figure, the system saves the best product and potential savings, including transaction costs, for the Borrower, step 1613.

Next, the system prepares a referral request, step 1620, which calls upon Borrowers to provide referral business to Mortgage Professionals via reply-mail. This is done on a periodic basis. Then the system generates and distributes a customer-service survey, polling the Borrowers about the Mortgage Professional's customer service efforts, step 1630. As a part of the process, all of the calculations, selections, alerts, reports and data from the Borrower has already been saved to the Output File on the Alerts Database. Finally, a copy of the Output file is also saved to the Local machine, step 1640, so that the User can see what Alerts are being prepared for delivery, ending the process, step 1650.

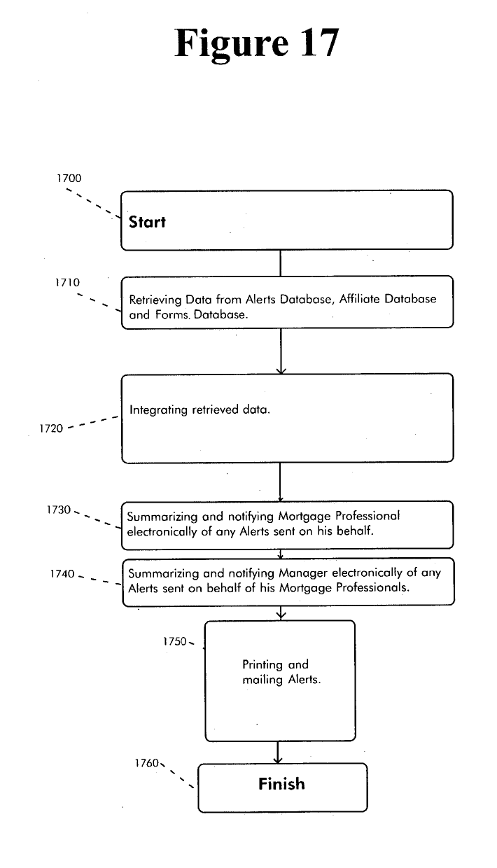

FIG. 17 is a flowchart showing a procedure for contacting Borrowers within an integrated mortgage advice system.

All of the output from the integrated mortgage advice system, including reports, alarms and other results, is saved into the Alerts Database. The process starts, step 1700, when the system retrieves data from the Alerts Database, Affiliate Database and Forms Database to create print files as needed, step 1710.

The Alerts Database contains all of the pertinent alert information. For example, an Alert Record would contain: name and address of Borrower; type of Alert the System has identified; Borrower's Mortgage Professional; and data or calculations to support suggested actions.

The Affiliate Database contains records about the Mortgage Professional's employer, including: the Mortgage Professional's name and contact information; photograph of the Mortgage Professional and company logo for the Affiliate; and the Mortgage Professional's digitized signature.

The Forms Database contains the format, text and other layout data for each of the Alerts that an integrated mortgage advice system sends. Examples of form letters: “No Change Advised” which advises a borrower when no action is probably the best action; “Savings Alert!” which advises a Borrower when to refinance and how much can be saved; “PMI Cancellation Imminent” which advises a Borrower how and when to cancel PMI as well as how much can be saved; “Happy Holidays” which is friendly holiday greeting from the Mortgage Professional to the Borrower; and “Thank you for your business” which is a thank you notice from the Mortgage Professional to the Borrower.

The system then integrates data, step 1720, from these three databases to create print files or other types of output. Next, the system summarizes the alerts and notifies the Mortgage Professional of any alerts that are sent on his behalf, step 1730. The system then notifies the Manager of any Alerts that were sent to members of his chain of command, step 1740.

Finally, the Administrator prints and sends the Alerts to the Borrowers, step 1750, ending the procedure at step 1760.

We claim:

1. A computer-based integrated mortgage advice system comprising:
an input system, receiving data from a plurality of input sources, wherein the plurality of input sources comprises a borrower, a mortgage professional, and a lender;
a data storage system linked to the input system; wherein the data storage system further comprises a plurality of databases, wherein the plurality of databases comprises a borrower database, an affiliate database and a lender database;
an integration and maintenance system linked to the data storage system, wherein the integration and maintenance system further comprises an alerts database;
an analyzer linked to the integration and maintenance system, wherein the analyzer performs a periodic analysis for the borrower, wherein the periodic analysis comprises determination of a mortgage insurance cancellation timeline, interest rate monitoring, changes in a borrower's credit rating, a property market value for a borrower's property, and a best combination of mortgage products for a borrower;
an output system linked to the analyzer; and
an objectives system linked to the output system, wherein the objectives system uses a plurality of alerts from the alerts database to provide refinancing or other mortgage information to the borrower.

2. The computer-based integrated mortgage advice system of claim 1, wherein the analyzer determines the best combination of mortgage products for a borrower through a comparison of a plurality of mortgage products against a borrower's vital data and the property market value.

3. The computer-based integrated mortgage advice system of claim 1, wherein the objectives system prints the plurality of alerts from the alerts database.

4. A method of operating a computer-based integrated mortgage advice system, comprising the steps of:
(a) collecting a vital data for a borrower;
(b) entering the vital data into a borrower database;
(c) selecting a plurality of mortgage products from a lender database;
(d) using the vital data, searching for a savings opportunity for the borrower within the plurality of mortgage products;
(e) outputting a series of reports to a mortgage professional which explains the savings opportunity for the borrower within the plurality of mortgage products whereby the mortgage professional can inform the borrower of the savings opportunity; and
(f) executing the steps of the method for the borrower on a periodic basis.

5. The method of operating a computer-based integrated mortgage advice system of claim 4, wherein step (d) further comprises the steps of:
(d1) checking for a local database connection;
(d2) when the local database connection is available, comparing a username and password with an approved access list;
(d3) approving the username and password;
(d4) validating a user and computer;
(d5) when the user and computer are validated, selecting a borrower's record for analysis; and
(d6) updating the vital data within the borrower's record.

6. The method of operating a computer-based integrated mortgage advice system of claim 5, wherein step (d2) further comprises the steps of:
(i) when the local database connection is not available, displaying “database unavailable”; and
(ii) exiting the system.

7. The method of operating a computer-based integrated mortgage advice system of claim 5, wherein step (d5) further comprises the steps of:
(i) when the user and computer are not validated, displaying “database unavailable”; and
(ii) exiting system.

8. The method of operating a computer-based integrated mortgage advice system of claim 5, further comprising the steps of:
(d7) selecting a search for a money-saving refinance opportunity;
(d8) using the vital data, calculating a refinance savings from the plurality of mortgage products and the vital data; and
(d9) when the refinance savings are available, displaying a mortgage product with the savings opportunity.

9. The method of operating a computer-based integrated mortgage advice system of claim 8, wherein step (d9) further comprises the step of:
(i) when the savings opportunity is not available, displaying the mortgage product with a lowest amount of loss.

10. The method of operating a computer-based integrated mortgage advice system of claim 5, further comprising the steps of:
(d7) selecting a search for a mortgage insurance savings;
(d8) using the vital data, calculating a loan-to-value ratio for a borrower's property;
(d9) determining a mortgage insurance cancellation eligibility for the borrower;
(d10) when the borrower is eligible for the mortgage insurance cancellation, determining an amount mortgage insurance savings from the mortgage insurance cancellation; and
(d11) determining an amount of mortgage interest savings based on the amount of mortgage insurance savings.

11. The method of operating a computer-based integrated mortgage advice system of claim 10, wherein step (d10) further comprising the steps of:
(i) when the borrower is not eligible for the mortgage insurance cancellation, projecting a mortgage insurance eligibility cancellation date.

12. The method of operating a computer-based integrated mortgage advice system of claim 10, wherein step (d11) further comprising the steps of:
(i) calculating an amount of mortgage interest paid during an original mortgage that is paid on schedule;
(ii) applying a monthly mortgage insurance premium to a monthly payment of the original mortgage to create a modified monthly mortgage payment;
(iii) calculating an amount of mortgage interest paid during the original mortgage using the modified monthly mortgage payment; and
(iv) comparing the amount of mortgage interest paid during the original mortgage that is paid on schedule to an amount of mortgage interest paid during a modified mortgage using the modified monthly mortgage payment.

13. The method of operating a computer-based integrated mortgage advice system of claim 5, further comprising the steps of:
(d7) selecting a search for a mortgage consolidation benefit;
(d8) using the vital data and a plurality of refinancing products, calculating consequences of a refinancing of borrower's property;
(d9) using the vital data, calculating consequences of a second mortgage on borrower's property from a plurality of second mortgage products;
(d10) comparing consequences of the refinancing of borrower's property to consequences of the second mortgage on borrower's property to determine a best choice;
(d11) comparing the best choice to a current mortgage plan for the borrower;
(d12) determining if a net savings for the borrower results; and
(d13) displaying a product with the savings opportunity for the borrower.

14. The method of operating a computer-based integrated mortgage advice system of claim 13, wherein step (d13) further comprises the steps of:
(i) if no savings opportunity for the borrower results, displaying the product with a lowest loss to the borrower.

15. The method of operating a computer-based integrated mortgage advice system of claim 5, further comprising the steps of:
(d7) selecting a search for an alternative mortgage payment plan benefit;
(d8) using the vital data, calculating consequences of a weekly mortgage payment plan;
(d9) using the vital data, calculating consequences of a biweekly mortgage payment plan;
(d10) using the vital data, calculating consequences of a monthly mortgage payment plan;
(d11) comparing the weekly mortgage payment plan, the biweekly mortgage payment plan, and the monthly mortgage payment plan to an original borrower's mortgage payment plan to determine a mortgage interest savings opportunity; and
(d12) displaying the mortgage interest savings and the associated mortgage payment plan.

16. A method of operating a computer-based integrated mortgage advice system comprising the steps of:
(a) selecting a vital data of a borrower by a mortgage professional;
(b) selecting a search for refinance savings for a borrower's mortgage;
(c) calculating a refinance savings based on the vital data;
(d) saving the refinance savings to an alerts database;
(e) determining if the borrower has an adjustable rate mortgage anniversary approaching;
(f) when the adjustable rate mortgage anniversary is approaching, saving a reminder to the alerts database;
(g) determining a current equity for a borrower's property;
(h) saving the current equity results to the alerts database;
(i) determining a credit rating change for the borrower;
(j) saving the credit rating change results to the alerts database;
(k) determining a market value of the borrower's property;
(l) determining a mortgage insurance cancellation eligibility for the borrower's property;
(m) when the borrower's property is eligible for the mortgage insurance cancellation, determining a mortgage insurance savings;
(n) calculating a mortgage interest savings resulting from the mortgage insurance cancellation;
(o) saving the mortgage interest savings resulting from the mortgage insurance cancellation to the alerts database; and
(p) producing a report based upon the mortgage interest savings results in the alerts database.

17. The method of operating a computer-based integrated mortgage advice system of claim 16, further comprising the steps of:
(q) determining if the borrower has used the integrated mortgage advice system on the borrower's mortgage in the past; and
(r) if the borrower has not used the integrated mortgage advice system on the borrower's mortgage in the past, saving a thank you note reminder in the alerts database.

18. The method of operating a computer-based integrated mortgage advice system of claim 16, further comprising the steps of:
(q) determining if the borrower's mortgage has a biweekly mortgage payment plan; and
(r) if the borrower's mortgage does not have the biweekly mortgage payment plan; saving a summary of various payment plan benefits for the borrower's mortgage to the alerts database.

19. The method of operating a computer-based integrated mortgage advice system of claim 16, further comprising the steps of:
(q) determining if the borrower has a second mortgage on the borrower's property;
(r) if the borrower has the second mortgage on the borrower's property, performing a comparison of a refinance of the borrower's mortgage to the second mortgage; and
(s) saving the comparison of the second mortgage to the refinance in the alerts database.

20. The method of operating a computer-based integrated mortgage advice system of claim 16, further comprising the steps of:
(q) searching a lender database for a mortgage product that offers a best savings for the borrower;
(r) determining a best long-term savings for the borrower;
(s) saving the best long-term savings to the alerts database;
(t) determining a best short-term savings for the borrower; and
(u) saving the best short-term savings to the alerts database.

21. The method of operating a computer-based integrated mortgage advice system of claim 16, further comprising the steps of:
(q) generating a business referral request for the borrower; and
(r) saving the business referral request to the alerts database.

22. The method of operating a computer-based integrated mortgage advice system of claim 16, further comprising the steps of:
(q) generating a customer service survey for the borrower; and
(r) saving the customer service survey to the alerts database.

23. The method of operating a computer-based integrated mortgage advice system of claim 16, further comprising the steps of:
(q) retrieving a plurality of reports from the alerts database;
(r) integrating the plurality of reports from the alerts database;
(s) sending a summary of the plurality of reports to the mortgage professional; and
(t) printing and mailing the plurality of reports to the borrower.

24. An article of manufacture comprising:
a computer usable medium having computer readable program code means embodied therein for causing an integrated mortgage advice system to be executed on a periodic basis, the computer readable program code means in said article of manufacture comprising:
computer readable program code means for causing a computer to select a vital data of a borrower by a mortgage professional;
computer readable program code means for causing a computer to select a search for refinance savings for a borrower's mortgage;
computer readable program code means for causing a computer to calculate a refinance savings based on the vital data;
computer readable program code means for causing a computer to save the refinance savings to an alerts database;
computer readable program code means for causing a computer to determine if the borrower has an adjustable rate mortgage anniversary approaching;
computer readable program code means for causing a computer to, when the adjustable rate mortgage anniversary is approaching, save a reminder to the alerts database;
computer readable program code means for causing a computer to determine a current equity for a borrower's property;
computer readable program code means for causing a computer to save the current equity results to the alerts database;
computer readable program code means for causing a computer to determine a credit rating change for the borrower;
computer readable program code means for causing a computer to save the credit rating change results to the alerts database;
computer readable program code means for causing a computer to determine a market value of the borrower's property;
computer readable program code means for causing a computer to determine a mortgage insurance cancellation eligibility for the borrower's property;
computer readable program code means for causing a computer to, when the borrower's property is eligible for the mortgage insurance cancellation, determine a mortgage insurance savings;
computer readable program code means for causing a computer to calculate a mortgage interest savings resulting from the mortgage insurance cancellation;
computer readable program code means for causing a computer to save the mortgage interest savings resulting from the mortgage insurance cancellation to the alerts database; and
computer readable program code means for causing a computer to produce a report based upon the mortgage interest savings results in the alerts database.
